(19) United States
(12) Patent Application Publication
(10) Pub. No.: US 2020/0180003 A1
(43) Pub. Date: Jun. 11, 2020

(54) METHOD FOR OPERATING A BENDING MACHINE

(71) Applicant: TRUMPF Maschinen Austria GmbH & Co. KG., Pasching (AT)

(72) Inventors: Thomas JUNGMAYR, Marchtrenk (AT); Rudolf KUBINGER, Kallham (AT); Johann MAYRHOFER, Nussbach (AT)

(73) Assignee: TRUMPF Maschinen Austria GmbH & Co. KG., Pasching (AT)

(21) Appl. No.: 16/345,856

(22) PCT Filed: Nov. 17, 2017
(86) PCT No.: PCT/AT2017/060304

§ 371 Date: Apr. 29, 2019

(30) Foreign Application Priority Data
Nov. 18, 2016 (AT) A 51050/2016

(51) Int. Cl. B21D 5/02; B21D 5/00; B21D 55/00

(52) U.S. Cl. CPC B21D 5/0272; B21D 5/006; F16P 3/144; B21D 5/004; B21D 55/00

(57) ABSTRACT

The invention relates to a method for bending of a workpiece (2) along a straight bending line (27), by means of a first bending tool (5) and a second bending tool (6) of a press brake (3), wherein the region between the two bending tools (5, 6) is monitored for the presence of obstacles by means of a safety system (30), by a control apparatus (24), during the approach movement between the first bending tool (5) and the second bending tool (6). Subsequently, the position of the bending line (27) of the stress-relieved and pre-bent workpiece (2) is determined in relation to a center plane (40) of the first (5) and/or of the second bending tool (6), by means of the safety system (30). On the basis of a control signal, a correction of the position of the workpiece (2) is is carried out, until the position deviation (42) of the bending line (27) lies within a permissible maximal deviation from the center plane (40). Subsequently, the workpiece (2) is bent to its final angle.

The invention relates to a method for bending of a workpiece along a straight bending line.

Safety devices for a bending machine and methods for bending of sheet-metal parts are known from DE 10 2007 006 306 A1 and DE 10 2004 020 024 A1. The safety devices have a light emitter and a light receiver, between which the bending tools are disposed.

The methods described in DE 10 2007 006 306 A1 and DE 10 2004 020 024 A1 have the disadvantage that only insufficient precision can be achieved during bending of the sheet-metal workpieces.

It was the task of the present invention to overcome the disadvantages of the state of the art and to make available a method by means of which sheet-metal workpieces can be produced with great precision.

This task is accomplished by means of an apparatus and a method in accordance with the claims.

According to the invention, a method for bending of a workpiece along a straight bending line, by means of a first bending tool and a second bending tool of a press brake is provided. The method comprises the steps:
placement of the workpiece between the two bending tools;
displacement of the first bending tool in the direction toward the second bending tool, wherein the region between the two bending tools is monitored for the presence of obstacles by means of a safety system, by a control apparatus, during the approach movement between the first bending tool and the second bending tool, wherein the safety system has a light source disposed on a first longitudinal side of the press brake and an optical detection means disposed on a second longitudinal side of the press brake, which means corresponds with the light source;
pre-bending of the workpiece to a pre-bending angle, which fits between a first bending shank and a second bending shank;
removal from one another of the two bending tools, until the workpiece is relieved of stress;
measurement of the bending angle on the stress-relieved workpiece and evaluation of the deformation behavior of the workpiece, in particular determination of the elastic recovery;
determination of the position of the bending line of the stress-relieved and pre-bent workpiece in relation to a center plane of the first and/or of the second bending tool, wherein the safety system is used for determination of the position of the bending line, and wherein if an established maximally permissible deviation of the position of the bending line from the center plane is determined by means of the control apparatus, a control signal is generated, and on the basis of the control signal, a correction of the position of the workpiece is carried out, until the position of the bending line lies within a permissible maximal deviation from the center plane;
displacement of the first bending tool in the direction toward the second bending tool and thereby re-bending of the workpiece, taking into consideration the determined deformation behavior of the workpiece, until a final bending angle is achieved.

An advantage of the method according to the invention is that a possible undesirable position change of the workpiece, which can occur during stress-relief of the workpiece for measurement of the bending angle, can be detected by means of the safety system, and subsequent, corresponding information can be made available to the user. As a result, the precision of the workpiece can be improved, since the workpiece can be positioned for the further bending step, in such a manner that the bending is continued at the same location, within a tolerance limit.

Furthermore, it can be practical if, in addition to the determination of the position of the bending line of the stress-relieved and pre-bent workpiece by means of the safety system, the position of the angle bisector between the bending shanks is determined, and an angle deviation of the angle bisector from the center plane is calculated by means of the control apparatus, wherein if an established maximally permissible angle deviation of the angle bisector from the center plane is exceeded, a control signal is generated by means of the control apparatus, and, on the basis of the control signal, a correction of the angle deviation of the workpiece is carried out, until the angle deviation lies within a permissible maximal deviation from the center plane. In this regard, it is advantageous that by means of this measure, it can be guaranteed that the workpiece is always placed into the press brake symmetrically. Furthermore, the result can be achieved, in this way, that the workpiece continues to be bent, after stress relief, precisely at the same location and precisely at the same angle as before stress relief.

Furthermore, it can be provided that the control signal is output to an operator of the press brake as an optical and/or acoustical warning signal. It is advantageous, in this regard, that the operator's attention can be drawn to possible incorrect positioning of the workpiece by means of the control signal, and that the operator is therefore able to correct the position of the workpiece.

Furthermore, it can be provided that in addition to the optical and/or acoustical warning signal, a representation of the position deviation of the bending line and/or of the direction deviation of the angle bisector is output to an operator of the press brake by means of a display apparatus. It is advantageous, in this regard, that by means of this measure, not only does the operator receive the warning that the position of the workpiece is not correct, but rather that in addition, the information is also provided, at the same time, as to how the workpiece must be displaced or rotated so as to correct its position.

An embodiment according to which it can be provided that the control signal triggers a correction movement of a workpiece manipulator that holds the workpiece during the bending procedure is also advantageous. In this way, the workpiece can be brought into its correct position by means of the workpiece manipulator.

According to a further development, it is possible that the control signal triggers a correction movement of the first bending tool or of the second bending tool. It is advantageous, in this regard, that the bending tools are used for the purpose of carrying out a correction of the position or of the orientation of the workpiece.

Furthermore, it can be practical if the bending angle of the stress-relieved workpiece is detected by means of sensing elements. It is advantageous, in this connection, that sensing elements can have great precision for detection of the bending angle, and furthermore can be produced in simple manner.

Furthermore, it can be provided that the pre-bending angle and/or the bending angle of the stress-relieved workpiece is/are detected by means of the safety system. It is advantageous, in this regard, that by means of this measure, no additional measurement means for detection of the bending angle are required.

Furthermore, it can be provided that the procedure for re-bending of the workpiece can only be carried out when the position of the bending line and/or the deviation of the angle bisector from the center plane lie(s) within a tolerance range.

By means of this measure, the result can be achieved that starting of the further bending procedure is blocked as long as the workpiece is not properly put in place, and thereby the production of scrap is reduced.

According to a special embodiment, it is possible that the position of the bending line is determined in that tangents laid against the inside of the bending shanks are determined, and the bending line is assumed to lie at the intersection of the two tangents. It is advantageous, in this regard, that by means of this measure, the position of the bending line can be reliably determined in the case of workpieces having different configurations, and also in the case of different bending angles.

For a better understanding of the invention, it will be explained in greater detail below, using the following figures.

These show, each in a greatly simplified, schematic representation:

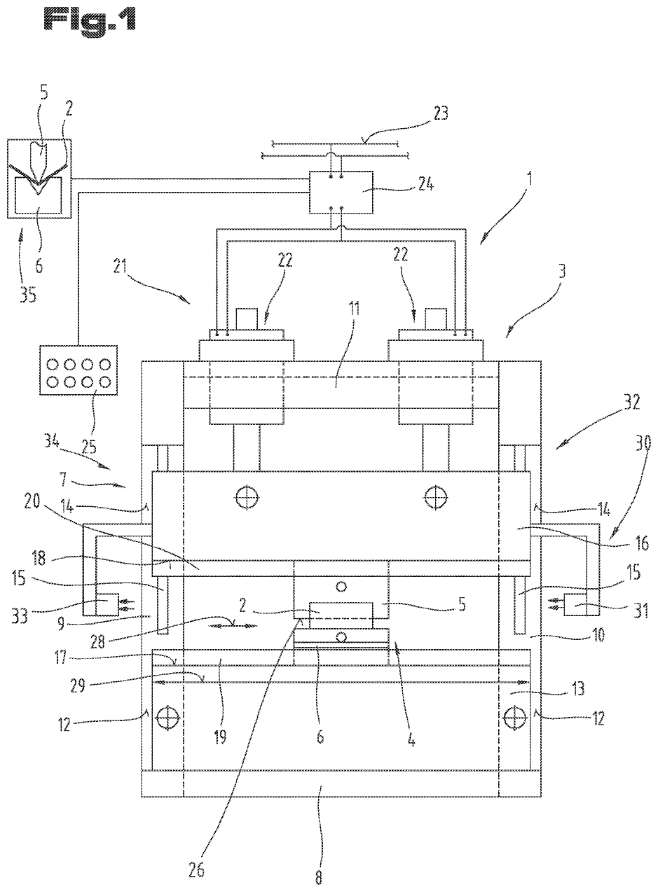

FIG. 1 a schematic representation of an exemplary embodiment of a press brake;

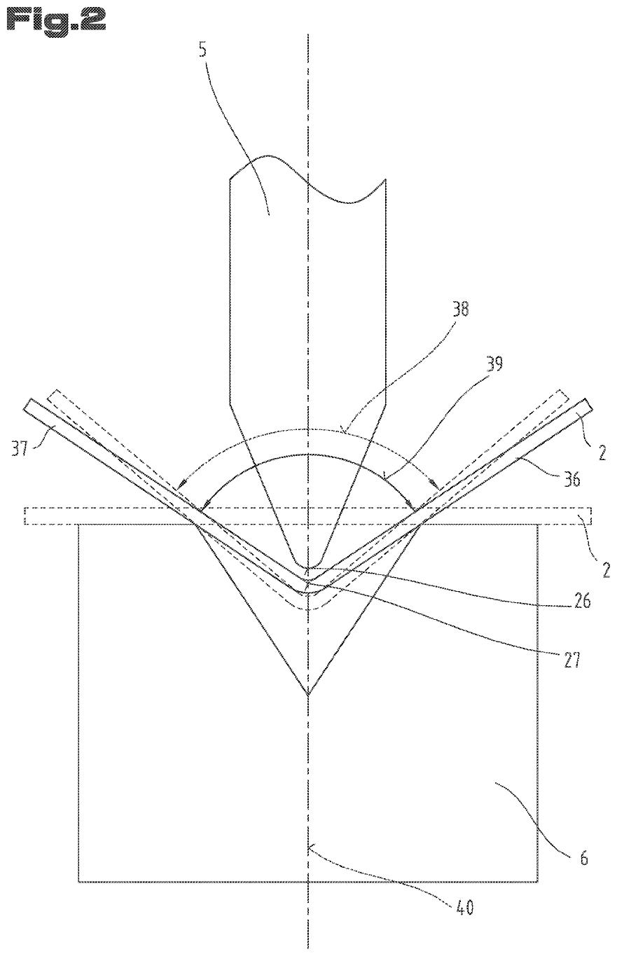

FIG. 2 a detail view of a bending tool, with representation of the bending steps of pre-bending and stress relief for measurement of the deformation behavior of the workpiece;

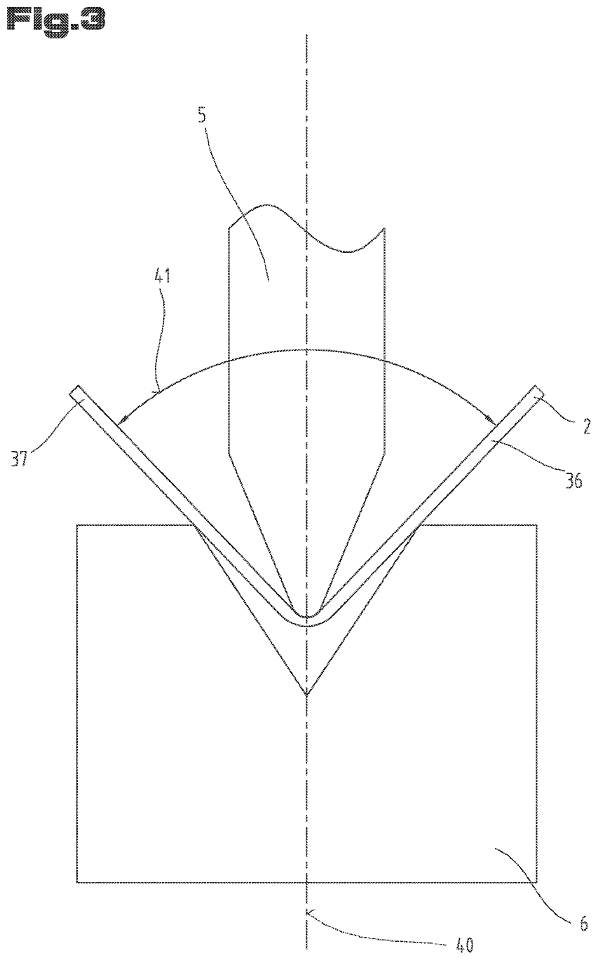

FIG. 3 a detail view of a bending tool, with representation of the bending step of final bending;

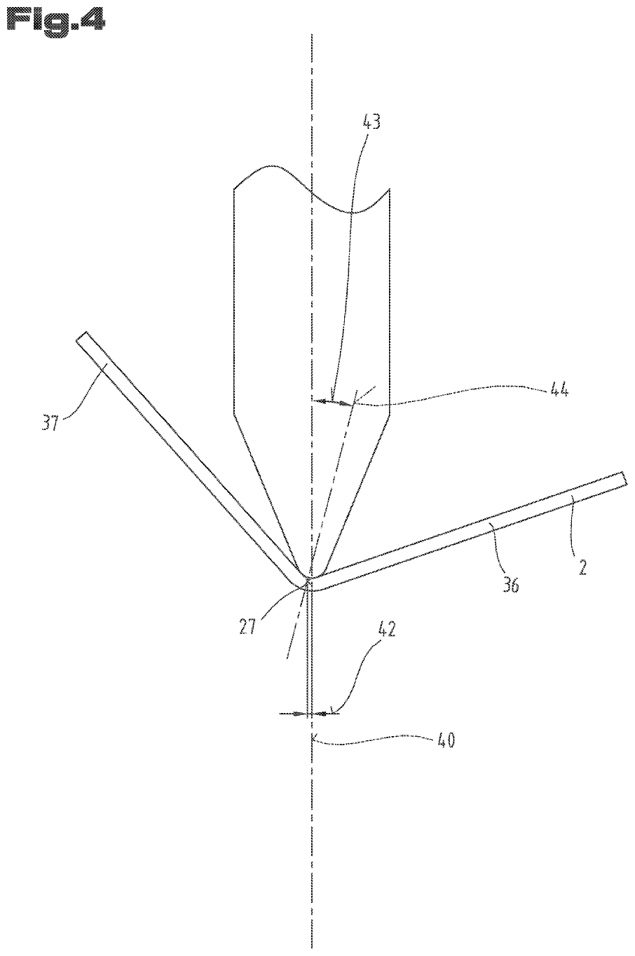

FIG. 4 a detail view of a bending tool, with representation of a workpiece inserted in exaggeratedly skewed manner.

As an introduction, it should be stated that in the different embodiments described, the same parts are provided with the same reference symbols or the same component designations, wherein disclosures contained in the description as a whole can be applied analogously to the same parts having the same reference symbols or component designations. Also, the position information selected in the description, such as at the top, at the bottom, at the side, etc., for example, relates only to the figure being directly described and shown, and this position information must be applied analogously to a new position in the case of a change in position.

In FIG. 1, an embodiment variant of a production system 1 for free bending of workpieces 2 to be produced from sheet metal is shown in a schematically simplified representation.

The production system 1 comprises a press brake 3 for bending of the workpieces 2 or work parts between bending tool combinations 4 that are adjustable relative to one another. In particular, it can be provided that the bending tool combinations 4 comprise at least a first bending tool 5 in the form of a bending punch and at least a second bending tool 6 in the form of a bending die. In this regard, the first bending tool 5 can also be referred to as an upper tool, and the second bending tool 6 can also be referred to as a lower tool. Furthermore, it can be provided that the bending tool combination 4 has multiple first bending tools 5 and multiple second bending tools 6.

A machine frame 7 of the press brake 3 comprises a floor plate 8, for example, on which side walls 9, 10 that project vertically upward and are spaced apart from one another in the transverse direction and oriented parallel to one another can be disposed. These are preferably connected with one another by means of a solid transverse bracing 11, for example formed from a sheet-metal formed part, at their end regions that are at a distance from the floor plate 8.

The side walls 9, 10 can be formed approximately in C shape to form a free space for forming of the workpiece 2, wherein a fixed press beam 13, in particular one standing on the floor plate 8, can be attached to front end faces 12 of shanks of the side walls 9, 10 that are close to the floor. This press beam 13 can also be referred to as a table beam. A further press beam 16, in particular a pressure beam, which is adjustable relative to the press beam 13 forming the table beam, can be mounted on shanks of front end faces 14 that are at a distance from the floor plate 8, which beam is guided in linear guides 15.

Tool holders 19, 20 for being fitted with the bending tools 5, 6 can be disposed or configured on end faces 17, 18 of the two press beams 13, 16, which faces lie opposite one another and run parallel to one another.

The press brake 3 shown has at least one, here two drive means 22 as a drive arrangement 21 for the adjustable press beam 16, namely the pressure beam, which are supplied, for example, with electrical energy from a power network 23 or by means of a hydraulic circuit, and, in addition, can also be line-connected with a control apparatus 24. Operation of the press brake 3 is controlled, for example, by way of an input terminal 25 that is line-connected with the control apparatus 24.

All of the embodiment characteristics or individual characteristics of the figure description mentioned above are mentioned so as to describe an exemplary production system 1 or bending press 3, to which reference can be made in the following part of the figure description, which is essential to the invention. All of the individual characteristics described are therefore not absolutely required for the embodiment according to the invention, and can be left out or replaced with other characteristics, so as to obtain a functioning press brake 3.

The bending tools 5, 6 have a bending edge 26, which extends in a longitudinal direction of the bending tool 5, 6. The bending edge 26 also defines the progression of the bending line 27 on the workpiece 2 to be bent. The bending tools 5, 6 are held in the tool holder 19, 20 in such a manner that they can be displaced in a direction 28 that is parallel to the bending edge 26, if necessary. In particular, it can be provided that the bending tools 4 are displaceable over the entire length 29 of the tool holder 19, 20.

Furthermore, a safety system 30 is provided, which serves for monitoring of the bending procedure. The safety system 30 comprises a light source 31, which is disposed on a first longitudinal side 32 of the press brake 3. Furthermore, the safety system 30 comprises an optical detection means 33, which is disposed on a second longitudinal side 34 of the press brake 3.

In particular, it is provided, in this regard, that a light beam is emitted by the light source 31, and detected and evaluated by the optical detection means 33. The bending tools 5, 6 and also the workpiece 2 are disposed between the light source 31 and the optical detection means 33, and therefore cast a shadow on the optical detection means 33. Thereby an outer contour of the bending tools 5, 6 and of the workpiece 2 can be recognized at the optical detection means 33.

Furthermore, obstacles, such as a hand of the machine operator, for example, can be recognized by the optical detection means 33. Thereby an obstacle can be recognized by the safety system 30, which is not provided for during the conventional bending sequence, and subsequently the bending procedure can be stopped by means of the control apparatus 24, so as to prevent damage to the press brake 3 or injury of the machine operator.

As is evident from FIG. 1, it can be provided that the light source 31 and/or the optical detection means 33 is/are disposed directly on the second press beam 16 and thereby can be displaced along with it.

Alternatively to this, it can also be provided that the light source 31 and/or the optical detection means 33 is/are disposed directly on the machine frame 7 and thereby are not displaced along with the second press beam 16, but rather disposed fixed in place on the press brake 3.

The safety system 30, aside from its function as a safety system, can also be used to monitor a correct position of the workpiece 2. If the workpiece 2 is not inserted correctly between the two bending tools 5, 6, a control signal can be issued by means of the control apparatus 24 with which the safety system 30 is coupled, by means of which signal the position or orientation of the workpiece 2 can be corrected.

Furthermore, a display apparatus 35 can be provided, by means of which the current position of the workpiece 2 or the reference position of the workpiece 2 can be displayed to the machine operator, thereby making it possible for the machine operator to carry out a correction of the position of the workpiece 2.

FIGS. 2 and 3 show a sectional representation of an exemplary embodiment of the bending tools 5, 6 and of the workpiece 2, wherein once again, the same reference symbols or component designations are used for the same parts as in the preceding FIG. 1. In order to avoid unnecessary repetition, reference is made to the detailed description of the preceding FIG. 1, i.e. this is pointed out.

In FIG. 2, individual bending steps, pre-bending of the workpiece 2 along the straight bending line 27 and stress relief of the workpiece 2 for measurement of the deformation behavior of the workpiece 2, are shown schematically.

In FIG. 3, the bending step of final bending of the workpiece 2 along the straight bending line 27 is shown.

As is evident from FIG. 2, the straight and as yet non-bent workpiece 2 is inserted between the two bending tools 5, 6. In particular, it is provided, in this regard, that the workpiece 2 is laid onto the second bending tool 6.

Subsequently, the first bending tool 5 is moved in the direction toward the second bending tool 6, wherein it is monitored, by means of the safety system 30, whether there might be an object, such as the hand of the machine operator, for example, situated in the hazard zone between the first bending tool 5 and the second bending tool 6.

If no unplanned object is disposed between the first bending tool 5 and the second bending tool 6, these are moved toward one another to such an extent until the bending edge 26 of the first bending tool 5 comes to lie against the workpiece 2.

During the further movement of the first bending tool 5 toward the second bending tool 6, the bending tools 5, 6 act on the workpiece 2 in such a manner that it is formed by means of the bending edge 26 of the first bending tool 5, along a bending line 27. As a result of the bending procedure, a first bending shank 36 and a second bending shank 37, which each follow the bending line 27, are formed on the workpiece 2.

The first bending tool 5 is moved so far in the direction toward the second bending tool 6 until a predetermined pre-bending angle 38 or one that can be predetermined is present between the two bending shanks 36, 37. The size of the pre-bending angle 38 can be detected, in a first exemplary embodiment, by means of a scanning system as described in DE 296 23 800 U1. Alternatively to this, it is conceivable that the pre-bending angle 38 is detected by means of the safety system 30. In yet another application, it is conceivable that the pre-bending angle 38 is detected by means of some other system for capture of the bending angle.

After capture of the pre-bending angle 38, the first bending tool 5 is moved away from the second bending tool 6 again, and thereby stress on the workpiece 2 is relieved. In this regard, the first bending tool 5 is moved away from the second bending tool 6 to such an extent until no force from the bending tools 5, 6 acts on the workpiece 2 any longer. By means of this procedure, spring-back of the workpiece 2 is made possible, wherein the workpiece 2 springs back by the elastic bending component. Subsequently, the bending angle 39 is measured on the stress-relieved workpiece 2 on the stress-relieved workpiece 2. To state it in different words, the bending angle 39 of the workpiece 2 in the stress-relieved state is measured.

The difference between pre-bending angle 38 and bending angle 39 of the stress-relieved workpiece 2 provides information about the deformation behavior of the workpiece 2. In particular, the elastic component of the bending of the workpiece 2 can be calculated from this. The elastic component of the bending of the workpiece 2 is dependent not only on the factors that can be calculated, such as material properties, sheet-metal thickness, etc., but also dependent on factors that cannot be determined in advance, such as the insertion or rolling direction of the workpiece 2 and variations in the component factors or material properties due to tolerances.

Subsequently, the position of the bending line 27 of the stress-relieved and pre-bent workpieces in relation to a center plane 40 of the first 5 and/or of the second bending tool 6 is detected by means of the safety system 30. If the bending line 27 of the workpiece 2 lies within a certain tolerance range with reference to the position of the center plane 40, the bending procedure can be continued, wherein the first bending tool 5 is once again moved toward the second bending tool 6 and the workpiece 2 is bent once again, until a final bending angle 41 is reached. In this regard, the final bending angle 41 is established on the basis of the reference bending angle and on the basis of the calculated deformation behavior of the workpiece 2.

In FIG. 4, a further position of the workpiece 2 is shown, wherein once again, the same reference symbols or component designations as in the preceding FIGS. 1 to 3 are used for the same parts. In order to avoid unnecessary repetition, reference is made to the detailed description of the preceding FIGS. 1 to 3, i.e. this is pointed out.

As is evident from FIG. 4, it can happen that during the method step of the stress relief of the workpiece 2 for determination of its bending angle 39, the workpiece 2 slips in terms of its position. As a result, it can happen that a position deviation 42 of the bending line 27 from the center plane 40 is greater than a maximally permissible deviation. If the bending procedure is continued without a position correction of the workpiece 2, the latter would not be bent cleanly. In order to prevent this, it is provided that the position deviation 42 of the bending line 27 from the center plane 40 is monitored and analyzed by means of the safety system 30. If the position deviation 42 exceeds a maximal value, a control signal is generated by means of the control apparatus 24, on the basis of which signal a correction of the position of the workpiece 2 can be carried out.

There are different possibilities for correction of the position of the workpiece 2, which can differ as a function of the degree of automation or of the composition of the workpiece 2. In the case of a press brake 3 with little automation, for example, it can be provided that the machine operator guides the workpiece 2 and that the control signal is an optical and/or acoustical signal, for example, which signals a correct or incorrect position of the workpiece 2 to the machine operator. For example, it can be provided that a beep sound or an optical signal is emitted up until the workpiece 2 has been brought into its correct position. To facilitate positioning of the workpiece 2, it can be provided that the current position of the workpiece 2 and the reference position of the workpiece 2 are superimposed in the display apparatus 35. By reading the display apparatus 35, the user can thereby be given help in the positioning procedure.

Furthermore, it can be provided that initiation of the further bending movement can only be carried out when the workpiece 2 is correctly positioned. As a result, the process reliability can be further increased, and the production of scrap goods can be prevented to the greatest possible extent.

In the case of an automated bending procedure, it is conceivable, for example, that the workpiece 2 is held and guided by means of a manipulation apparatus, and that the control signal is passed on directly for control of the manipulation apparatus.

In yet another exemplary embodiment, it is also conceivable that for correction of the position of the workpiece 2, the bending tools 5, 6 are displaced or moved relative to one another.

Aside from monitoring of the position of the bending line 27, it can also be provided that an angle deviation 43 of an angle bisector 44 of the workpiece 2 relative to the center plane 40 is monitored by means of the safety system 30.

The angle bisector 44 is the bisector between the first bending shank 36 and the second bending shank 37.

The correct angle position of the workpiece 2, just like the correct position of the bending line 27, can be corrected on the basis of a control signal, which is emitted by the control apparatus 24.

The exemplary embodiments show possible embodiment variants, wherein it should be noted at this point that the invention is not restricted to the embodiment variants of the same that are specifically shown, but rather various combinations of the individual embodiment variants with one another are possible, and this variation possibility lies within the ability of a person skilled in the art of this technical field, based on the teaching for technical action provided by the present invention.

The scope of protection is determined by the claims. However, the description and the drawings should be used for interpreting the claims. Individual characteristics or combinations of characteristics from the different exemplary embodiments that are shown and described can represent independent inventive solutions in and of themselves. The task on which the independent inventive solutions are based can be found in the description.

All information regarding value ranges in the present description should be understood to mean that these include any and all partial regions of them; for example, the information 1 to 10 should be understood to mean that all partial regions, starting from the lower limit 1 and including the upper limit 10 are included, i.e. all partial ranges start at a lower limit of 1 or more and end at an upper limit of 10 or less, for example 1 to 1.7, or 3.2 to 8.1, or 5.5 to 10.

For the sake of good order, it should be pointed out, in conclusion, that for a better understanding of the structure, some elements were shown not to scale and/or larger and/or smaller.

### REFERENCE SYMBOL LISTING

1 production system
2 workpiece
3 press brake
4 bending tool combination
5 first bending tool
6 second bending tool
7 machine frame
8 floor plate
9 side wall
10 side wall
11 transverse bracing
12 front end face
13 first press beam
14 front end face
15 linear guide
16 second press beam
17 end face
18 end face
19 first tool holder
20 second tool holder
21 drive arrangement
22 drive means
23 power network
24 control apparatus
25 input terminal
26 bending edge
27 bending line
28 parallel direction
29 length
30 safety system
31 light source
32 first longitudinal side
33 optical detection means
34 second longitudinal side
35 display apparatus
36 first bending shank
37 second bending shank
38 pre-bending angle
39 bending angle of stress-relieved workpiece
40 center plane
41 final bending angle
42 position deviation
43 angle deviation
44 angle bisector

1. A method for bending of a workpiece (2) along a straight bending line (27), by means of a first bending tool (5) and a second bending tool (6) of a press brake (3), comprising the steps:
placement of the workpiece (2) between the two bending tools (5, 6);
displacement of the first bending tool (5) in the direction toward the second bending tool (6), wherein the region between the two bending tools (5, 6) is monitored for the presence of obstacles by means of a safety system (30), by a control apparatus (24), during the approach movement between the first bending tool (5) and the second bending tool (6), wherein the safety system (30) has a light source (31) disposed on a first longitudinal side (32) of the press brake (3) and an optical detection means (33) disposed on a second longitudinal side (34) of the press brake, which means corresponds with the light source (31);
pre-bending of the workpiece (2) to a pre-bending angle (38), which fits between a first bending shank (36) and a second bending shank (37);
removal from one another of the two bending tools (5, 6), until the workpiece (2) is relieved of stress;
measurement of the bending angle (39) on the stress-relieved workpiece (2) and evaluation of the deformation behavior of the workpiece (2), in particular determination of the elastic recovery;
determination of the position of the bending line (27) of the stress-relieved and pre-bent workpiece (2) in relation to a center plane (40) of the first (5) and/or of the second bending tool (6), wherein the safety system (30) is used for determination of the position of the bending line (27), and wherein if an established maximally permissible deviation of the position of the bending line (27) from the center plane (40) is determined by means of the control apparatus (24), a control signal is generated, and on the basis of the control signal, a correction of the position of the workpiece (2) is carried out, until the position deviation (42) of the bending line (27) lies within a permissible maximal deviation from the center plane (40);
displacement of the first bending tool (5) in the direction toward the second bending tool (6) and thereby re-bending of the workpiece (2), taking into consideration the determined deformation behavior of the workpiece (2), until a final bending angle (41) is achieved.

2. The method according to claim 1, wherein in addition to the determination of the position of the bending line (27) of the stress-relieved and pre-bent workpiece (2) by means of the safety system (30), the position of the angle bisector (44) between the bending shanks (36, 37) is determined, and an angle deviation (43) of the angle bisector (44) from the center plane (40) is calculated by means of the control apparatus (24), wherein if an established maximally permissible angle deviation (43) of the angle bisector (44) from the center plane (40) is exceeded, a control signal is generated by means of the control apparatus (24), and, on the basis of the control signal, a correction of the angle deviation (43) of the workpiece (2) is carried out, until the angle deviation (43) lies within a permissible maximal deviation from the center plane (40).

3. The method according to claim 1, wherein the control signal is output to an operator of the press brake as an optical and/or acoustical warning signal.

4. The method according to claim 1, wherein in addition to the optical and/or acoustical warning signal, a representation of the position deviation of the bending line (27) and/or of the direction deviation of the angle bisector (44) is output to an operator of the press brake (3) by means of a display apparatus (35).

5. The method according to claim 1, wherein the control signal triggers a correction movement of a workpiece manipulator that holds the workpiece (2) during the bending procedure.

6. The method according to claim 1, wherein the control signal triggers a correction movement of the first bending tool (5) or of the second bending tool (6).

7. The method according to claim 1, wherein the bending angle (39) of the stress-relieved workpiece (2) is detected by means of sensing elements.

8. The method according to claim 1, wherein the pre-bending angle (38) and/or the bending angle (39) of the stress-relieved workpiece (2) is detected by means of the safety system (30).

9. The method according to claim 1, wherein the procedure for re-bending of the workpiece (2) can only be carried out when the position of the bending line (27) and/or the deviation of the angle bisector (44) from the center plane (40) lies within a tolerance range.

10. The method according claim 1, wherein the position of the bending line (27) is determined in that tangents laid against the inside of the bending shanks (36, 37) are determined, and the bending line (27) is assumed to lie at the intersection of the two tangents.
